(19) United States
(12) Patent Application Publication
(10) Pub. No.: US 2017/0260920 A1
(43) Pub. Date: Sep. 14, 2017

(54) CONTROL DEVICE AND CONTROL METHOD FOR INTERNAL COMBUSTION ENGINE

(71) Applicant: TOYOTA JIDOSHA KABUSHIKI KAISHA, Toyota-shi, Aichi-ken (JP)

(72) Inventor: Hayato NAKADA, Minamitsuru-gun (JP)

(73) Assignee: TOYOTA JIDOSHA KABUSHIKI KAISHA, Toyota-shi, Aichi-ken (JP)

(21) Appl. No.: 15/510,735

(22) PCT Filed: Sep. 16, 2015
(86) PCT No.: PCT/IB2015/001898

§ 371 Date: Mar. 13, 2017

(30) Foreign Application Priority Data
Sep. 17, 2014 (JP) 2014-188403

(51) Int. Cl. F02D 41/02; F01N 3/021; F02D 41/14

(52) U.S. Cl. CPC F02D 41/0235; F02D 41/1401; F01N 3/021; F01N 2900/1602

(57) ABSTRACT

A control device includes a feedback controller that determines an operation amount of an actuator by feedback control such that an actual value of a state quantity becomes closer to a target value, and a reference governor that modifies the target value such that an amount of change in the state quantity per unit time is equal to or less than an upper limit value β. The reference governor calculates a modified target value by adding one of 2ζβ/ωₙ and β/{(T₂/T₁)^{T}^{₂}^{/(T}^{₁}^{-T}^{₂}⁾−(T₂/T₁)^{T}^{₁}^{/(T}^{₁}^{-T}^{₂}⁾} to a current value of the state quantity (ζ, ωₙ: an attenuation coefficient, a natural angular frequency of a model formula in a case where a dynamic characteristic of a closed-loop system is modeled as a dead time plus second-order vibration system, T₁, T₂ =−ωₙ⁻¹(−ζ±\sqrt{(ζ²−1)}⁻¹), and determines the smaller one of the modified target value and an original target value as a final target value of the state quantity.

### BACKGROUND OF THE INVENTION

1. Field of the Invention

The invention relates to a control device and a control method for an internal combustion engine.

2. Description of Related Art

In general, a control device for an internal combustion engine is configured to determine a control input for the internal combustion engine by feedback control such that an output value of a control amount complies with a target value, in a case where the target value is given with regard to the control amount for the internal combustion engine. In many cases of actual internal combustion engine control, however, various hardware or control constraints are present with regard to the state quantity of the internal combustion engine. In a case where these constraints are not satisfied, hardware malfunctioning and a decline in control performance may occur. The capability of satisfying the constraints as well as the capability of the output value complying with the target value is one of the important performances required for internal combustion engine control.

A reference governor is effective means for satisfying the requirement. The reference governor is provided with a predictive model that models a closed-loop system (feedback control system) which includes a controlled object and a feedback controller, and predicts the future value of the state quantity on which the constraint is imposed by using the predictive model. Then, the target value of the control amount for the internal combustion engine is modified based on the predicted value of the state quantity and the constraint imposed thereon.

The related art in which the reference governor is applied to internal combustion engine control has already been described in Japanese Patent Application Publication No. 2013-084091 and Japanese Patent Application Publication No. 2014-084845. The control device relating to the related art is provided with the feedback controller and the reference governor. The feedback controller determines the operation amount of an actuator (variable nozzle and throttle valve of variable capacity turbo) by feedback control such that the actual value of a specific state quantity (supercharging pressure and filling efficiency) of the internal combustion engine becomes closer to a target value. The reference governor predicts the future trajectory of the specific state quantity by using the predictive model which models the dynamic characteristic of a closed-loop system relating to the feedback control as “dead time plus second-order vibration system” and modifies the target value such that the constraint is satisfied.

### SUMMARY OF THE INVENTION

In the reference governor described above, online calculation using the predictive model is performed. This is because the internal combustion engine is mounted on a vehicle and the modification of the target value has to be based on not offline calculation but the online calculation in order for the constraint to be satisfied as the target value of the specific state quantity changes from moment to moment due to the operation state and the operation condition of the vehicle. However, the arithmetic capacity of the control device mounted on the vehicle is not as large as the amount of calculation required for the online calculation using the predictive model. Accordingly, an calculation load on the control device may become large in a case where the online calculation using the predictive model is implemented in the vehicle-mounted control device.

The calculation load on the control device increases as the range of prediction of the future trajectory of the specific state quantity extends. With regard to this point, the range of prediction of the future trajectory of the specific state quantity using the predictive model is set to the total of the dead time of the predictive model and half of the vibration cycle of the secondary vibration system in the control device described above. This is advantageous in that the calculation for predicting the future trajectory of the specific state quantity is performed only when necessary. However, the prediction within the set prediction time may result in a decline in prediction accuracy and a conservative modification of the target value.

The invention provides a control device and a control method for an internal combustion engine with which the calculation load applied to the control device that performs online calculation using a predictive model is reduced and the modification of a target value can be accurately performed.

A first aspect of the invention relates to a control device for an internal combustion engine, the control device configured to control a specific state quantity of the internal combustion engine by operating an actuator. The control device includes: a feedback controller configured to determine an operation amount of the actuator by feedback control such that an actual value of the state quantity becomes closer to a target value; and a reference governor configured to modify the target value of the state quantity such that a constraint imposed on the state quantity is satisfied. The constraint is satisfied when an amount of change in the state quantity per unit time is equal to or less than an upper limit value β. The reference governor (34) is configured to calculate a modified target value as a value obtained by adding one of 2ζβ/ωₙ and β/{(T₂/T₁)^{T}^{₂}^{/(T}^{₂}^{-T}^{₂}⁾−(T₂/T₁)^{T}^{₁}^{-T}^{₂}⁾} to a current value of the state quantity when an attenuation coefficient ζ and a natural angular frequency ωₙ respectively indicate an attenuation coefficient and a natural angular frequency of a model formula in a case where a dynamic characteristic of a closed-loop system is modeled as a dead time plus second-order vibration system, and T₁ and T₂ are expressed as −ωₙ⁻¹(−ζ±\sqrt{(ζ²−1)})⁻¹, and is configured to determine the smaller one of the modified target value and an original target value as a final target value of the state quantity.

A second aspect of the invention relates to a control method for an internal combustion engine, in which a specific state quantity of the internal combustion engine is controlled by operating an actuator. The control method includes: determining an operation amount of the actuator by feedback control such that an actual value of the state quantity becomes closer to a target value; and modifying the target value of the state quantity such that a constraint imposed on the state quantity is satisfied. The constraint is satisfied when an amount of change in the state quantity per unit time is equal to or less than an upper limit value β. Modifying the target value of the state quantity includes calculating a modified target value as a value obtained by adding one of 2ζβ/ωₙ and β/{(T₂/T₁)^{T}^{₂}^{/(T}^{₁}^{-T}^{₂}⁾−(T₂/T₁)^{T}^{₁}^{/T}^{₁}^{-T}^{₂}⁾} to a current value of the state quantity when an attenuation coefficient ζ and a natural angular frequency ωₙ respectively indicate an attenuation coefficient and a natural angular frequency of a model formula in a case where a dynamic characteristic of a closed-loop system is modeled as a dead time plus second-order vibration system, and T₁ and T₂ are expressed as −ωₙ⁻¹(−ζ±\sqrt{(ζ²−1)})⁻¹, and determining the smaller one of the modified target value and an original target value as a final target value of the state quantity.

The state quantity may be a bed temperature of a diesel particulate filter disposed in an exhaust passage of a diesel engine, and the actuator may be a device adding a fuel to an upstream from the diesel particulate filter in the exhaust passage.

According to the configuration described above, a calculation load applied to the control device performing online calculation using the predictive model expressed as the dead time plus second-order vibration system can be reduced and the modification of the target value can be accurately performed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram illustrating the configuration of an aftertreatment system for a diesel engine;

FIG. 2 is a diagram illustrating a target value compliance control structure for the diesel engine in an ECU 30;

FIG. 3 is a diagram illustrating a model of a closed-loop system relating to feedback control that is surrounded by the dashed line in FIG. 2;

FIG. 4 is a diagram illustrating the dynamic characteristic of the closed-loop system relating to the feedback control that is surrounded by the dashed line in FIG. 2;

FIG. 5 is a diagram for showing a problem of a reference governor algorithm of the related art;

FIG. 6 is a diagram for showing the amount of change in DPF bed temperature per unit time during heating control for a DPF 16;

FIG. 7 is a diagram illustrating the result of a numerical simulation pertaining to a case where an original target value is modified based on Equation (18);

FIG. 8 is a diagram illustrating the result of a numerical simulation pertaining to a case where the original target value is not modified;

FIG. 9 is a diagram illustrating a reference governor algorithm according to a first embodiment;

FIG. 10 is a diagram for showing a problem of the first embodiment;

FIG. 11 is a diagram illustrating the result of the plotting of Equation (20);

FIG. 12 is a diagram illustrating the result of a numerical simulation pertaining to a case where the original target value is modified based on Equation (23); and

FIG. 13 is a diagram illustrating a reference governor algorithm according to a second embodiment.

### DETAILED DESCRIPTION OF EMBODIMENTS

Hereinafter, embodiments of the invention will be described with reference to accompanying drawings. In the drawings, like reference numerals will be used to refer to like elements, and repetitive description will be omitted. The invention is not limited to the embodiments described below.

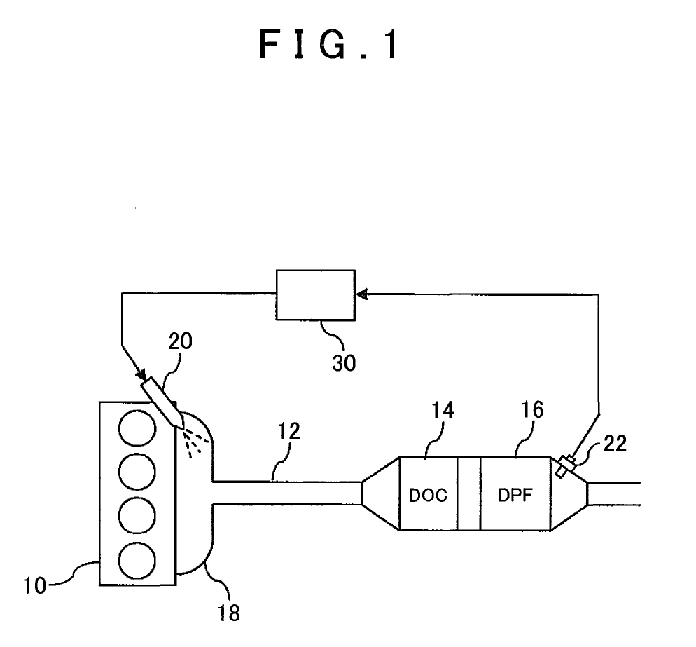

Firstly, a first embodiment of the invention will be described with reference to FIGS. 1 to 9.

A control device according to the first embodiment controls an aftertreatment system for an internal combustion engine that is mounted on a vehicle. FIG. 1 is a schematic diagram illustrating the configuration of the aftertreatment system for the internal combustion engine. The aftertreatment system that is illustrated in FIG. 1 is provided with a diesel engine 10 as the internal combustion engine, a diesel oxidation catalyst (DOC) 14 and a diesel particulate filter (DPF) 16 disposed in an exhaust passage 12 of the diesel engine 10, a fuel addition device 20 disposed in an exhaust port 18, and a temperature sensor 22 disposed downstream from the DPF 16. The DOC 14 is a catalyst that converts the hydrocarbon (HC) and carbon monoxide (CO) contained in exhaust gas into water (H₂O) and carbon dioxide (CO₂) by oxidation. The DPF 16 is a filter that collects the particulate components contained in the exhaust gas. The fuel addition device 20 is configured to add a fuel to the upstream from the DOC 14. The temperature sensor 22 is configured to measure the bed temperature of the DPF 16 (hereinafter, also referred to as a “DPF bed temperature”).

The aftertreatment system that is illustrated in FIG. 1 is also provided with an electronic control unit (ECU) 30. The ECU 30 is provided with a random access memory (RAM), a read-only memory (ROM), a central processing unit (CPU) as a microprocessor, and the like (none of which is illustrated herein). A program of a reference governor algorithm (described later) is stored in the ROM of the ECU 30.

In general, the fuel and a lubricant used in the diesel engine contain sulfur, and thus a sulfur compound (SOx) is generated as a result of the combustion of the fuel. When the SOx is generated in the diesel engine 10, the generated SOx is adsorbed onto the DPF 16 and the collecting function of the DPF 16 is reduced. In the first embodiment, heating control for the DPF 16 is executed by the ECU 30 so that the collecting function can be recovered. Specifically, the heating control for the DPF 16 is control for raising the DPF bed temperature to a temperature ranging from 300° C. to 700° C. by adding the fuel to an exhaust system from the fuel addition device 20. The heating control for the DPF 16 allows SOx to be desorbed from the DPF 16 and released to the atmosphere.

When the amount of change in DPF bed temperature per unit time during the heating control for the DPF 16 (hereinafter, also referred to as a “bed temperature gradient”) is large, the concentration of the SOx desorbed from the DPF 16 temporarily increases and the desorbed SOx is released to the atmosphere in a visible state, that is, in a white smoke state. In the first embodiment, a constraint (upper limit value β (degC/sec)) is imposed on the bed temperature gradient during the heating control for the DPF 16 so that the white smoke is prevented.

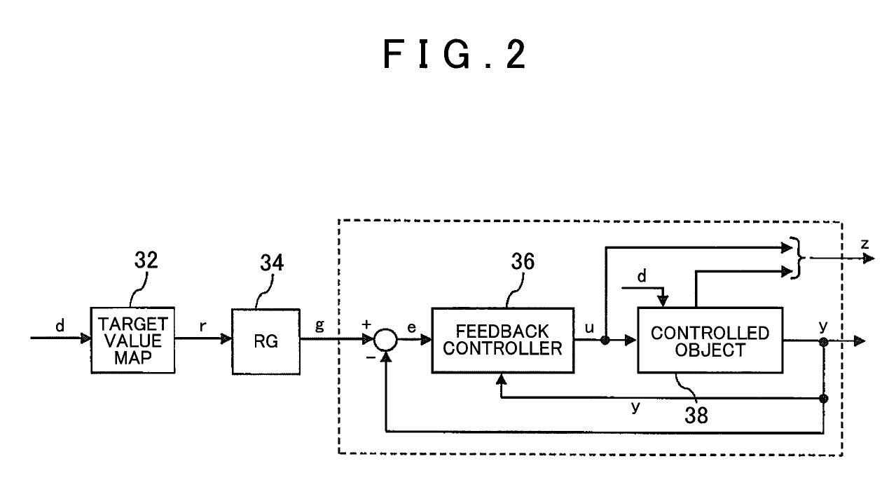

The ECU 30 is provided with a control structure that causes the DPF bed temperature to comply with a target value while maintaining the bed temperature gradient during the heating control for the DPF 16 at or below the upper limit value β. This control structure is the target value compliance control structure that is illustrated in FIG. 2. As illustrated in FIG. 2, the target value compliance control structure is provided with a target value map (MAP) 32, a reference governor (RG) 34, and a feedback controller 36.

When an exogenous input d that indicates the operation condition of the diesel engine 10 is given, the target value map 32 outputs a target value r of the DPF bed temperature that is a control amount. The exogenous input d includes an exhaust flow rate (mass flow rate) through the DPF 16 and an exhaust gas temperature at the upstream from the DPF 16. These physical quantities that are included in the exogenous input d may be measured values or estimated values.

The reference governor 34 modifies the target value of the DPF bed temperature by online calculation such that various hardware or control constraints are satisfied. Specifically, when the target value r of the DPF bed temperature is given, the reference governor 34 modifies the target value r such that the constraint relating to the bed temperature gradient is satisfied and outputs a modified target value g of the DPF bed temperature. In FIG. 2, a constrained signal z, which is the control input or control output signal, means the bed temperature gradient. As described above, the upper limit value is imposed on the bed temperature gradient z.

When the modified target value g of the DPF bed temperature is given from the reference governor 34, the feedback controller 36 acquires a current value y of the DPF bed temperature output from the temperature sensor 22 and determines a control input u to be given to a controlled object 38 by feedback control based on a deviation e between the modified target value g and the current value y. In the first embodiment, the controlled object is the aftertreatment system, and thus the operation amount of the fuel addition device 20 (that is, the amount of the fuel that is added to the exhaust system by the fuel addition device 20) is used as the control input u. The specifications of the feedback controller 36 are not limited, and a known feedback controller can be used as the feedback controller 36. For example, a proportional integral feedback controller can be used as the feedback controller 36.

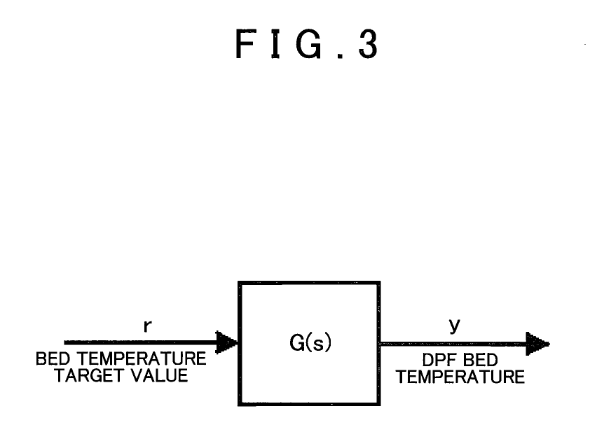

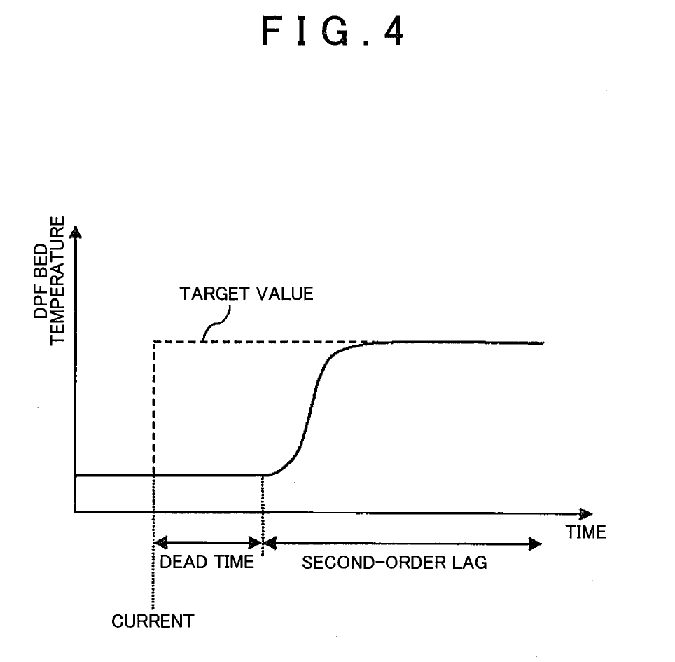

FIG. 3 is a diagram illustrating a model of a closed-loop system relating to the feedback control that is surrounded by the dashed line in FIG. 2. FIG. 4 is a diagram illustrating the dynamic characteristic of this closed-loop system. As illustrated in FIG. 3, this closed-loop system model is configured as a predictive model that outputs the DPF bed temperature y when the target value r of the DPF bed temperature (original target value r or modified target value g) is input. In this predictive model, the dynamic characteristic of the closed-loop system is modeled as “dead time plus second-order vibration (second-order lag) system” as illustrated in FIG. 4. This predictive model is expressed as the following model formula (1) by the use of the transfer function G(s) that is illustrated in FIG. 3.

y=G(s)r (1)

Specifically, the G(s) in Equation (1) is expressed as the following Equation (2). In Equation (2), “s” represents a differential operator, “ζ” represents an attenuation coefficient, “ωₙ” represents a natural angular frequency, and “L” represents dead time.

$$G ( s ) = \frac{{ω}_{n}^{2}}{{s}^{2} + 2 ζ {ω}_{n} s + {ω}_{n}^{2}} {e}^{- Ls} \qquad ( 2 )$$

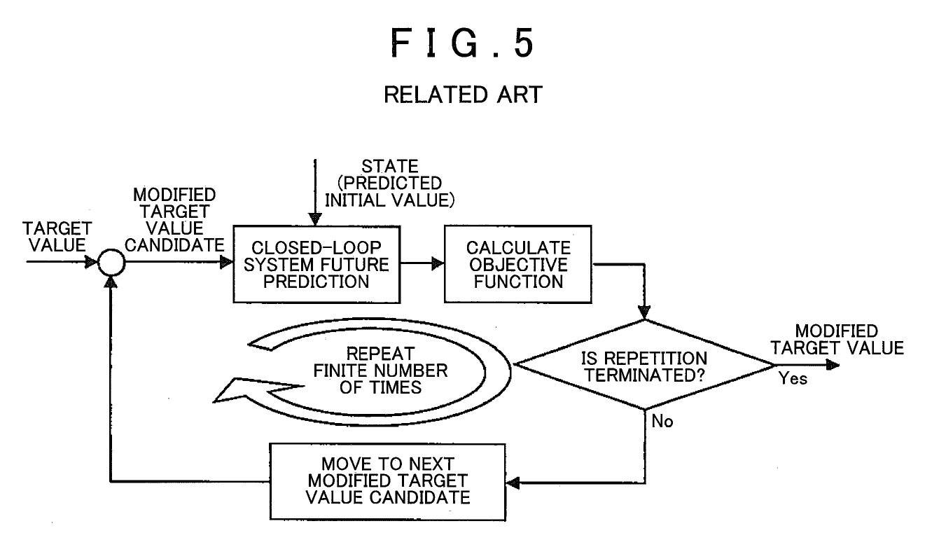

Hereinafter, a problem of the reference governor algorithm of the related art will be described with reference to FIG. 5. As with the first embodiment, this algorithm repeats future target value prediction a finite number of times by online calculation using a predictive model which models the dynamic characteristic of a closed-loop system. In this algorithm of the related art, however, the search for an optimum value for an objective function using a modified target value candidate as a variable is performed in addition to the future target value prediction using the predictive model, and thus the calculation load imposed on the ECU tends to increase. In addition, target value modification may be performed in a conservative manner in a case where the search for the optimum value for the objective function is aborted in a finite number of times.

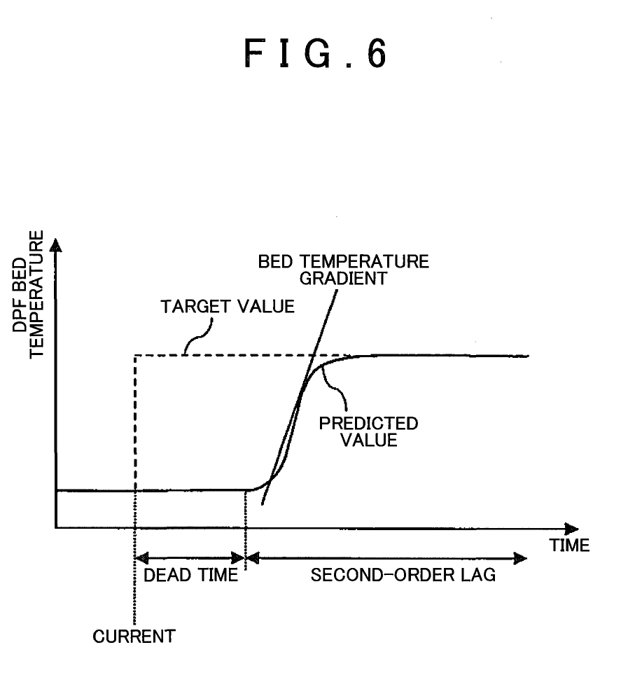

The inventor of the present application gave consideration to the problem and found that an optimally modified target value can be calculated online by mathematical future prediction. FIG. 6 is a diagram for showing the bed temperature gradient that should be noted in the present application. It is apparent in FIG. 6 that the dead time does not contribute to the bed temperature gradient in a case where the dynamic characteristic of the closed-loop system is modeled as the dead time plus second-order vibration (second-order lag) system. This shows that the dead time can be ignored in the calculation of the bed temperature gradient and the bed temperature gradient can be determined based solely on the second-order lag characteristic.

In Equation (2), the second-order lag characteristic is expressed as ωₙ²/s²+2ζωₙs+ωₙ² and the dead time characteristic is expressed as e^{-Ls}. In a case where the bed temperature gradient is expressed solely with the second-order lag characteristic, Equation (1) can be expressed as Equation (3).

$$y = \frac{{ω}_{n}^{2}}{{s}^{2} + 2 {ζω}_{n} s + {ω}_{n}^{2}} r \qquad ( 3 )$$

When Equation (3) is further modified based on T₁=−1/p₁ and T₂=−1/p₂, p₁ and p₂ being the solutions of the quadratic equation of (s²+2ζωₙs+ωₙ²=0) relating to the s pertaining to a case where the denominator on the right-hand side of Equation (3) is 0, Equation (4) is obtained

$$( {T}_{1} , {T}_{2} = - {{ω}_{n}^{- 1} ( - ζ \pm \sqrt{( {ζ}^{2} - 1 )} )}^{- 1} ) . \\ \begin{matrix}y = \frac{{ω}_{n}^{2}}{( s - {p}_{1} ) ( s - {p}_{2} )} r \\ = \frac{1}{( {T}_{1} s + 1 ) ( {T}_{2} s + 1 )} r \\ = \frac{1}{{T}_{1} - {T}_{2}} ( \frac{{T}_{1}}{{T}_{1} s + 1} - \frac{{T}_{2}}{{T}_{2} s + 1} ) r\end{matrix} \qquad ( 4 )$$

When the inverse Laplace transform formula shown in Equation (5) is applied to Equation (4), Equation (6) that indicates the bed temperature gradient is obtained.

$$\begin{matrix}G ( s ) = \frac{b}{s + a} ⇔ g ( t ) = {L}^{- 1} [ G ( s ) ] = {be}^{- at} & ( 5 ) \\ \dot{y} ( t ) = \frac{1}{{T}_{1} - {T}_{2}} ( {e}^{- \frac{t}{{T}_{1}}} - {e}^{- \frac{t}{{T}_{2}}} ) r & ( 6 )\end{matrix}$$

In a case where the bed temperature gradient is maximized (reaches the maximum gradient), the time differential value of Equation (6) is zero, and thus Equation (7) is obtained by the time differentiation of both sides of Equation (6).

$$\ddot{y} ( t ) = \frac{1}{{T}_{1} - {T}_{2}} ( - \frac{1}{{T}_{1}} {e}^{- \frac{t}{{T}_{1}}} + \frac{1}{{T}_{2}} {e}^{- \frac{t}{{T}_{2}}} ) r = 0 \qquad ( 7 )$$

In order for Equation (7) to be satisfied, the value in the parentheses on the right-hand side of Equation (7) may be zero. Accordingly, Equation (8) is obtained.

$$\frac{1}{{T}_{1}} {e}^{- \frac{t}{{T}_{1}}} = \frac{1}{{T}_{2}} {e}^{- \frac{t}{{T}_{2}}} \qquad ( 8 )$$

Equation (9) and Equation (10) are obtained when Equation (8) is further modified.

$$\begin{matrix}- ln {T}_{1} - \frac{t}{{T}_{1}} = - ln {T}_{2} - \frac{t}{{T}_{2}} & ( 9 ) \\ ( \frac{1}{{T}_{1}} - \frac{1}{{T}_{2}} ) t = ln \frac{{T}_{2}}{{T}_{1}} & ( 10 )\end{matrix}$$

The time tₘₐₓ that is taken for the bed temperature gradient to be maximized after the initiation of the heating control for the DPF 16 can be expressed as in Equation (11) with Equation (10) modified with regard to t.

$${t}_{max} = {( \frac{1}{{T}_{1}} - \frac{1}{{T}_{2}} )}^{- 1} ln \frac{{T}_{2}}{{T}_{1}} \qquad ( 11 )$$

Equation (12) is obtained when Equation (6) is organized with Equation (11).

$$\begin{matrix}{\dot{y}}_{max} = \frac{1}{{T}_{1} - {T}_{2}} \{ {e}^{- \frac{1}{{T}_{1}} {( \frac{1}{{T}_{1}} - \frac{1}{{T}_{2}} )}^{- 1} ln \frac{{T}_{2}}{{T}_{1}}} - {e}^{- \frac{1}{{T}_{2}} {( \frac{1}{{T}_{1}} - \frac{1}{{T}_{2}} )}^{- 1} ln \frac{{T}_{2}}{{T}_{1}}} \} r \\ = \frac{1}{{T}_{1} - {T}_{2}} \{ {( \frac{{T}_{2}}{{T}_{1}} )}^{\frac{{T}_{2}}{{T}_{1} - {T}_{2}}} - {( \frac{{T}_{2}}{{T}_{1}} )}^{\frac{{T}_{1}}{{T}_{1} - {T}_{2}}} \} r\end{matrix} \qquad ( 12 )$$

At the time tₘₐₓ, the coefficient of the denominator on the right-hand side of Equation (12) is maximized, and thus the maximum value g₁ₘₐₓ of the bed temperature gradient with respect to the unit step response can be expressed as in Equation (13). In addition, Equation (14) is satisfied at the time tₘₐₓ regarding the r on the right-hand side of Equation (12), and thus Equation (15) is obtained. In Equation (14), T_{dpf}^{ref} represents the target value of the DPF bed temperature and T_{dpf} represents the DPF bed temperature.

$$\begin{matrix}{g}_{1 max} := \{ {( \frac{{T}_{2}}{{T}_{1}} )}^{\frac{{T}_{2}}{{T}_{1} - {T}_{2}}} - {( \frac{{T}_{2}}{{T}_{1}} )}^{\frac{{T}_{1}}{{T}_{1} - {T}_{2}}} \} & ( 13 ) \\ r := {T}_{dpf}^{ref} - {T}_{dpf} & ( 14 ) \\ {\dot{y}}_{max} = {g}_{1 max} ( {T}_{dpf}^{ref} - {T}_{dpf} ) & ( 15 )\end{matrix}$$

The constraint described above is satisfied when the bed temperature gradient at the time tₘₐₓ is equal to or less than the upper limit value β. In other words, Expression (16) is satisfied in a case where the constraint is satisfied.

\dot{y}ₘₐₓ=g₁ₘₐₓ(T_{dpf}^{ref}−T_{dpf})≦β (16)

Expression (17) is obtained when Expression (16) is organized with regard to the target value T_{dpf}^{ref} of the DPF bed temperature.

$${T}_{dpf}^{ref} \leq {T}_{dpf} + \frac{β}{{g}_{1 max}} \qquad ( 17 )$$

Accordingly, the constraint relating to the bed temperature gradient is theoretically satisfied when the target value T_{dpf}^{ref} of the DPF bed temperature is modified based on Equation (18) obtained from Equation (17). In Equation (18), T_{dpf}^{ref,mod} represents the modified target value of the DPF bed temperature and T_{dpf} represents the current DPF bed temperature.

$${T}_{dpf}^{ref , mod} = {T}_{dpf} + \frac{β}{{g}_{1 max}} \qquad ( 18 )$$

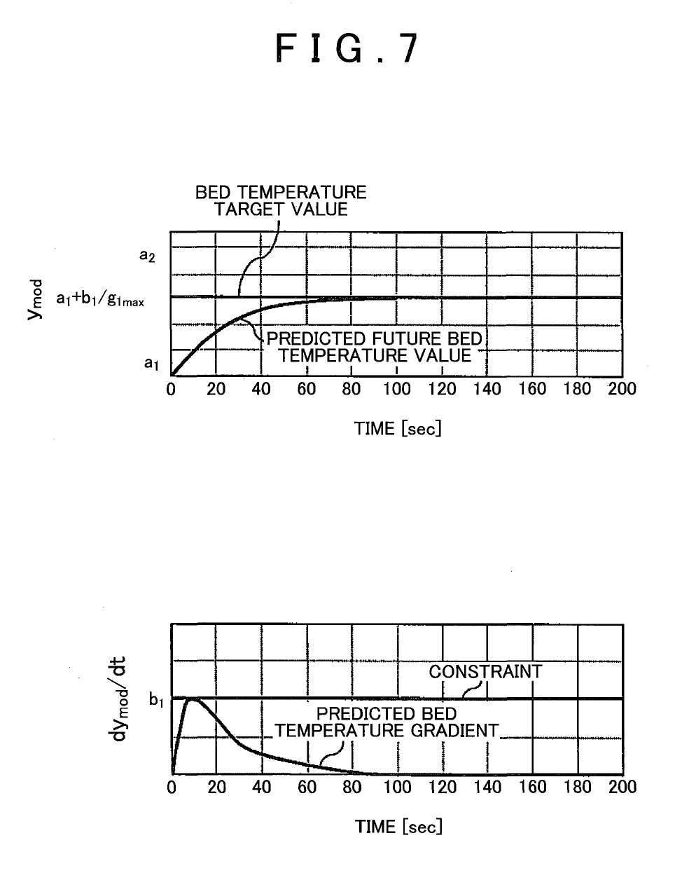

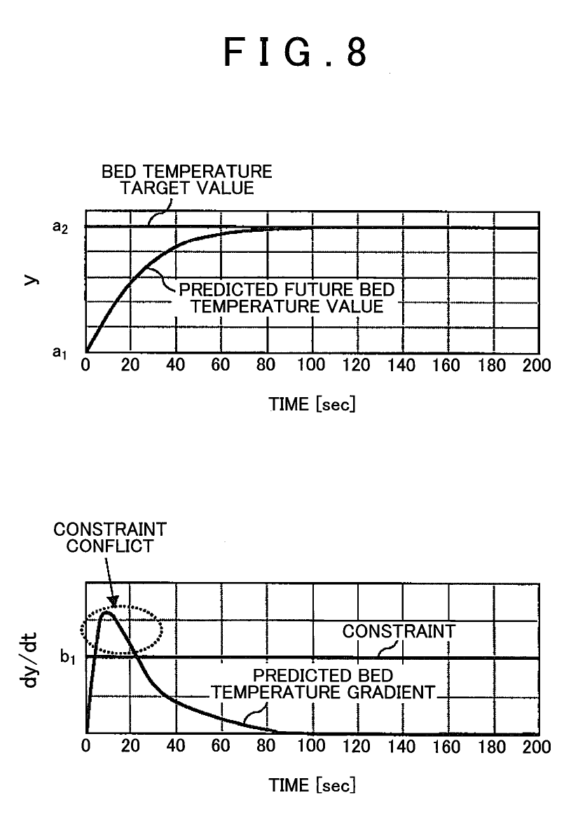

The effect of the target value modification based on Equation (18) will be described with reference to FIGS. 7 and 8. FIG. 7 is a diagram illustrating the result of a numerical simulation pertaining to a case where the original target value is modified based on Equation (18). FIG. 8 is a diagram illustrating the result of a numerical simulation pertaining to a case where the original target value is not modified. The numerical simulations in FIGS. 7 and 8 are performed by using the model formula of Equation (1), assuming the current DPF bed temperature T_{dpf} as a₁ and the upper limit value β as b₁ (each of a₁ and b₁ being a fixed value), predicting the future value of the DPF bed temperature by inputting the target value T_{dpf}^{ref} of the DPF bed temperature at time 0 (target value T_{dpf}^{ref} being constant in the simulation periods), and predicting the bed temperature gradient from the predicted future value.

In a case where a₂ (fixed value) is input as the target value T_{dpf}^{ref} of the DPF bed temperature at the time 0 (FIG. 8), the predicted value of the bed temperature gradient exceeds the upper limit value β and conflicts with the constraint. In a case where T_{dpf}+β/g₁ₘₐₓ(=a₁+b₁/g₁ₘₐₓ) is input as the target value T_{dpf}^{ref} of the DPF bed temperature at the time 0 (FIG. 7), the predicted value of the bed temperature gradient is equal to or less than the upper limit value β and the constraint is satisfied. This means that the constraint relating to the bed temperature gradient is satisfied in the target value modification based on Equation (18).

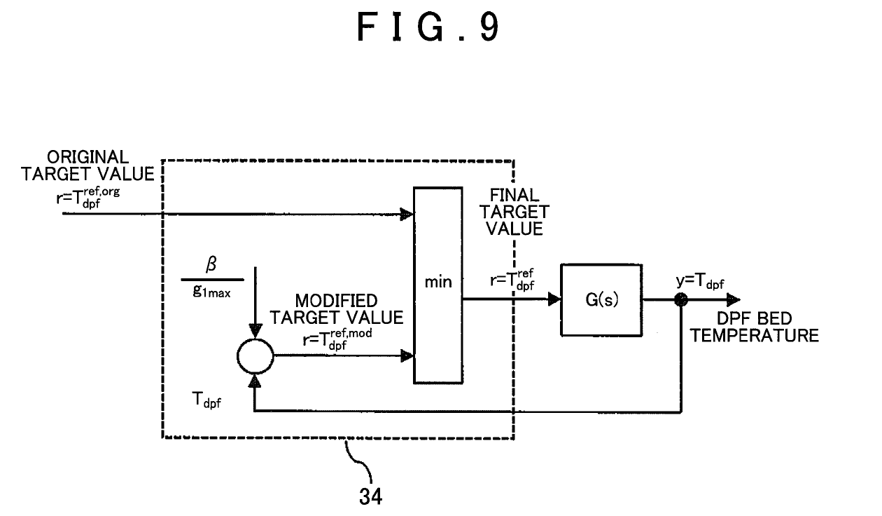

FIG. 9 is a diagram illustrating the reference governor algorithm according to the first embodiment. In the first embodiment, the smaller one of the original target value T_{dpf}^{ref,org} of the DPF bed temperature and the modified target value T_{dpf}^{ref,mod} of the DPF bed temperature is determined as the final target value r=T_{dpf}^{ref} when the heating control for the DPF 16 as illustrated in FIG. 9 is performed. The modified target value T_{dpf}^{ref,mod} is calculated as the value that is obtained by adding β/g₁ₘₐₓ to the current DPF bed temperature T_{dpf} (Equation (18)).

In the first embodiment, the target value of the DPF bed temperature can be modified, while the constraint relating to the bed temperature gradient is satisfied, based on the online calculation using Equation (18) which is mathematically obtained as described above. With this target value modification based on Equation (18), the future target value prediction and the search for the optimum value for the objective function described with reference to FIG. 5 do not have to be performed, and thus the calculation load imposed on the ECU 30 can be greatly reduced.

According to the first embodiment, the bed temperature gradient during the heating control for the DPF 16 is maintained at or below the upper limit value β as described above. However, effects similar to those of the first embodiment can be achieved even when the DPF 16 is replaced with the DOC 14. This is because the SOx generated in the diesel engine 10 may be adsorbed onto the DOC 14, the SOx is desorbed from the DOC 14 when heating control is executed for the DOC 14, the concentration of the SOx desorbed from the DOC 14 temporarily increases when the amount of change in the bed temperature of the DOC 14 per unit time during the heating control is large, and the desorbed SOx is released to the atmosphere in a white smoke state. This modification example can also be similarly applied with regard to a second embodiment (described later).

In the first embodiment, the aftertreatment system for a diesel engine has been described as the controlled object. However, a reference governor algorithm similar to that of the first embodiment can be established even in a case where another system capable of modeling the dynamic characteristic of a closed-loop system relating to feedback control as the dead time plus second-order vibration (second-order lag) system is the controlled object. An example of such systems is one that determines the operation amount of an actuator (variable nozzle, throttle valve, and EGR valve of variable capacity turbo) by feedback control such that the actual value of an engine state quantity (supercharging pressure, filling efficiency, and EGR rate) becomes closer to a target value. It is assumed that an upper limit value is imposed on the amount of change in state quantity per unit time. This modification example can also be similarly applied with regard to the second embodiment (described later).

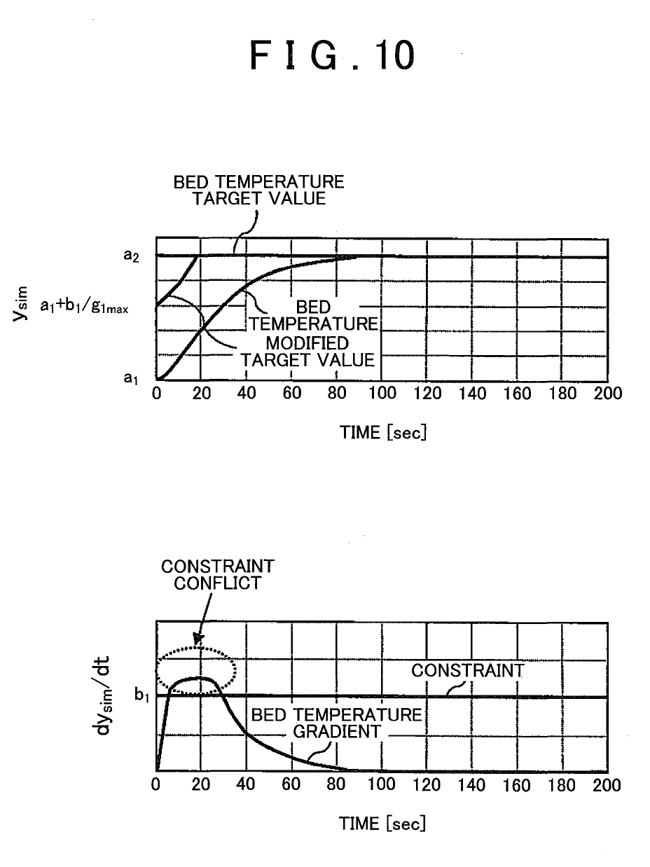

Hereinafter, the second embodiment of the invention will be described with reference to FIGS. 10 to 13. The following description of the second embodiment assumes, as in the description of the first embodiment, that the aftertreatment system for a diesel engine is the controlled object and the ECU 30 has a target value compliance control structure similar to that of the first embodiment. Accordingly, the following description will focus on how the second embodiment differs from the first embodiment.

FIG. 10 is a diagram for showing a problem of the first embodiment. In the numerical simulation that is illustrated in FIG. 7, the target value T_{dpf}^{ref} of the DPF bed temperature is assumed to be constant during the simulation period. However, the target value T_{dpf}^{ref} should rise from moment to moment during the actual heating control for the DPF 16 as a result of a rise in DPF bed temperature. FIG. 10 shows the result of a numerical simulation performed in view of this point. In the numerical simulation illustrated in FIG. 10, T_{dpf}+β/g₁ₘₐₓ (=a₁+b₁/g₁ₘₐₓ) is input as the target value T_{dpf}^{ref} of the DPF bed temperature at the time 0, and then this target value T_{dpf}^{ref} is modified every 8 ms.

As illustrated in FIG. 10, the predicted value of the bed temperature gradient exceeds the upper limit value β and conflicts with the constraint by approximately 25% in a case where the target value T_{dpf}^{ref} of the DPF bed temperature is modified during the simulation period. Equation (20) relating to a temporal gradient is obtained when an impulse response is obtained by applying an inverse Laplace transform formula to Equation (19) that represents the output which results from the input of β/g₁ₘₐₓ into the model illustrated in FIG. 3 so as to obtain the maximum value of the amount of the conflict (maximum conflict amount).

$$\begin{matrix}y = \frac{{ω}_{n}}{2 ζ} ( \frac{1}{s} - \frac{1}{s + 2 {ζω}_{n}} ) \frac{β}{{g}_{1 max}} & ( 19 ) \\ \dot{y} ( t ) = \frac{{ω}_{n}}{2 ζ} ( 1 - {e}^{- {ζω}_{n} t} ) \frac{β}{{g}_{1 max}} & ( 20 )\end{matrix}$$

Equation (21) is obtained when both sides of Equation (20) are time-differentiated so that the maximum conflict amount is obtained. However, the value on the right-hand side of Equation (21) is always positive, and thus the maximum conflict amount cannot be obtained.

$$\ddot{y} ( t ) = \frac{{ω}_{n}}{2 ζ} ( {ζω}_{n} {e}^{- {ζω}_{n} t} ) \frac{β}{{g}_{1 max}} \qquad ( 21 )$$

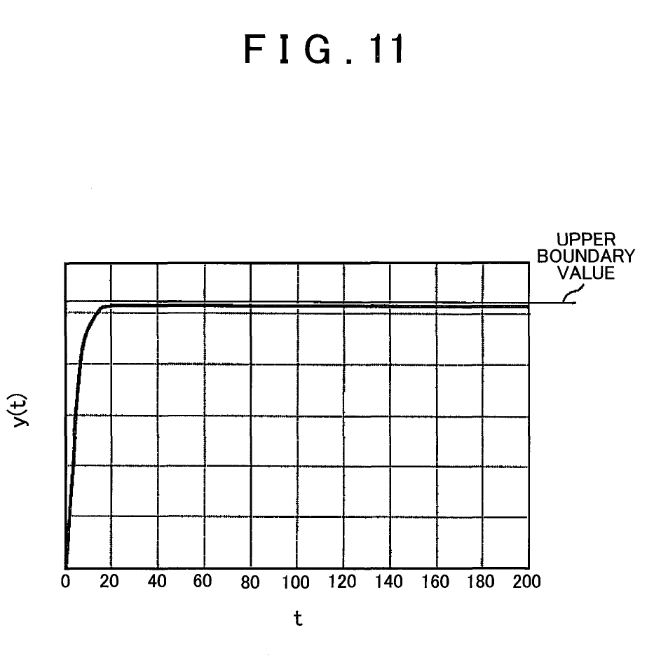

The inventor of the present application gave further consideration to the problem and found that the upper boundary value of a heating gradient can be obtained although the maximum value of the conflict amount cannot be obtained. FIG. 11 is a diagram illustrating the result of the plotting of Equation (20). When the limit value of Equation (20) is obtained, Equation (22) showing the upper boundary value of the heating gradient is obtained based on this result.

$${lim}_{t -> ∞} \dot{y} ( t ) = \frac{{ω}_{n}}{2 ζ {g}_{1 max}} β \qquad ( 22 )$$

Equation (22) means that the upper boundary value of the bed temperature gradient during the heating control for the DPF 16 is ωₙ/2ζg₁ₘₐₓ times the upper limit value β. Accordingly, a constraint relating to the bed temperature gradient at an actual response is satisfied when the target value T_{dpf}^{ref} of the DPF bed temperature is modified based on Equation (23), in which β/g₁ₘₐₓ of Equation (18) is divided by ωₙ/2ζg₁ₘₐₓ, in the modification of the target value of the DPF bed temperature.

$${T}_{dpf}^{ref , mod} = {T}_{dpf} + \frac{2 ζβ}{{ω}_{n}} \qquad ( 23 )$$

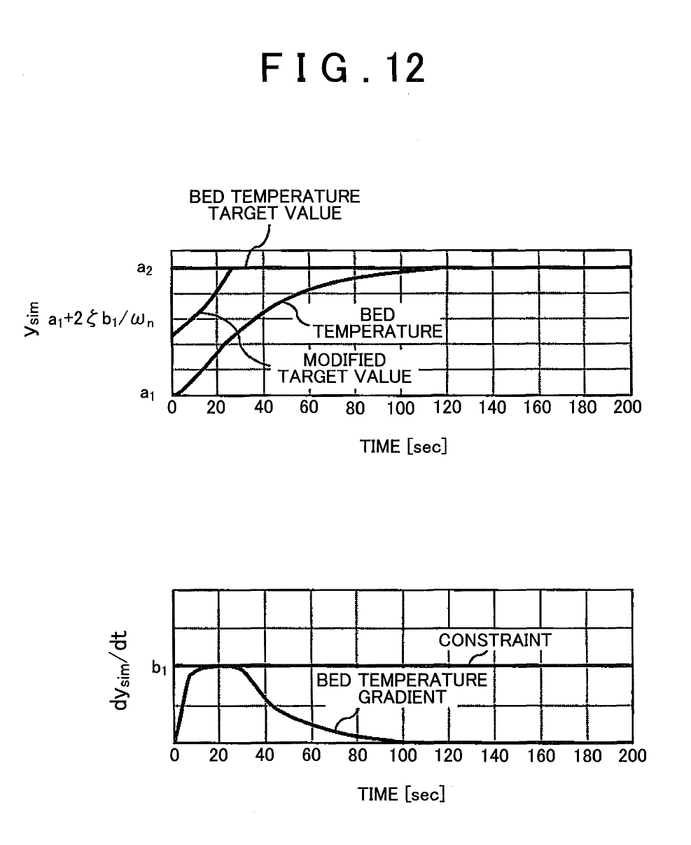

Effects of the target value modification based on Equation (23) will be described with reference to FIG. 12. FIG. 12 is a diagram illustrating the result of a numerical simulation pertaining to a case where the original target value is modified based on Equation (23). In the numerical simulation in FIG. 12, T_{dpf}+2ζβ/ωₙ (=a₁+2ζb₁/ωₙ) is input as the target value T_{dpf}^{ref} of the DPF bed temperature at the time 0, and then this target value T_{dpf}^{ref} is modified every 8 ms as in the numerical simulation in FIG. 10.

In a case where a₁+2ζb₁/ωₙ is input as the target value T_{dpf}^{ref} of the DPF bed temperature at the time 0 as illustrated in FIG. 12, the predicted value of the bed temperature gradient is equal to or less than the upper limit value β and the constraint is satisfied. This means, in other words, that the constraint relating to the bed temperature gradient at the actual response is satisfied in the target value modification based on Equation (23).

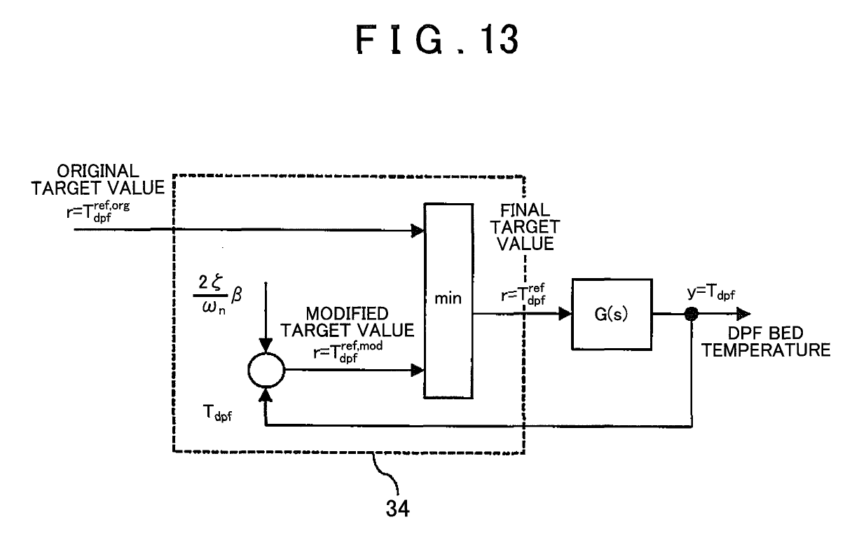

FIG. 13 is a diagram illustrating the reference governor algorithm according to the second embodiment. In the second embodiment, the smaller one of the original target value T_{dpf}^{ref,org} of the DPF bed temperature and the modified target value T_{dpf}^{ref,mod} of the DPF bed temperature is determined as the final target value r=T_{dpf}^{ref} during the heating control for the DPF 16 as illustrated in FIG. 13. The modified target value T_{dpf}^{ref,mod} is calculated as the value that is obtained by adding 2ζβ/ωₙ to the current DPF bed temperature T_{dpf} (Equation (23)).

According to the second embodiment, the target value of the DPF bed temperature can be modified, while the constraint relating to the bed temperature gradient at the actual response is satisfied, based on the online calculation using Equation (23) as described above. With this target value modification based on Equation (23), the future target value prediction and the search for the optimum value for the objective function described with reference to FIG. 5 do not have to be performed, and thus the calculation load imposed on the ECU 30 can be reduced.

1. A control device for an internal combustion engine, the control device configured to control a specific state quantity of the internal combustion engine by operating an actuator, the control device comprising:
a feedback controller configured to determine an operation amount of the actuator by feedback control such that an actual value of the state quantity becomes closer to a target value; and
a reference governor configured to modify the target value of the state quantity such that a constraint imposed on the state quantity is satisfied,
wherein the constraint is satisfied when an amount of change in the state quantity per unit time is equal to or less than an upper limit value β, and
wherein the reference governor is configured to calculate a modified target value as a value obtained by adding one of 2ζβ/ωₙ and β/{(T₂/T₁)^{T}^{₁}^{-T}^{₂}⁾−(T₂/T₁)^{T}^{₁}^{/(T}^{₁}^{-T}^{₂}⁾} to a current value of the state quantity when an attenuation coefficient ζ and a natural angular frequency ωₙ respectively indicate an attenuation coefficient and a natural angular frequency of a model formula in a case where a dynamic characteristic of a closed-loop system is modeled as a dead time plus second-order vibration system, and T₁ and T₂ are expressed as −ωₙ⁻¹(−ζ±\sqrt{(ζ²−1)})⁻¹, and is configured to determine a smaller one of the modified target value and an original target value as a final target value of the state quantity.

2. The control device according to claim 1,
wherein the state quantity is a bed temperature of a diesel particulate filter disposed in an exhaust passage of a diesel engine, and
wherein the actuator is a device adding a fuel to an upstream from the diesel particulate filter in the exhaust passage.

3. A control method for an internal combustion engine, in which a specific state quantity of the internal combustion engine is controlled by operating an actuator, the control method comprising:
determining an operation amount of the actuator by feedback control such that an actual value of the state quantity becomes closer to a target value; and
modifying the target value of the state quantity such that a constraint imposed on the state quantity is satisfied,
wherein the constraint is satisfied when an amount of change in the state quantity per unit time is equal to or less than an upper limit value β, and
wherein modifying the target value of the state quantity includes
calculating a modified target value as a value obtained by adding one of 2ζβ/ωₙ and β/{(T₂/T₁)^{T}^{₂}^{/(T}^{₁}^{-T}^{₂}⁾−(T₂/T₁)^{T}^{₁}^{/T}^{₁}^{-T}^{₂}⁾} to a current value of the state quantity when an attenuation coefficient ζ and a natural angular frequency ωₙ respectively indicate an attenuation coefficient and a natural angular frequency of a model formula in a case where a dynamic characteristic of a closed-loop system is modeled as a dead time plus second-order vibration system, and T₁ and T₂ are expressed as −ωₙ⁻¹(−ζ±\sqrt{(ζ²−1)})⁻¹, and
determining a smaller one of the modified target value and an original target value as a final target value of the state quantity.

4. The control method according to claim 3,
wherein the state quantity is a bed temperature of a diesel particulate filter disposed in an exhaust passage of a diesel engine, and
wherein the actuator is a device adding a fuel to an upstream from the diesel particulate filter in the exhaust passage.
